(19) United States
(12) Patent Application Publication
(10) Pub. No.: US 2025/0019985 A1
(43) Pub. Date: Jan. 16, 2025

(54) LIFT NUT MOUNTING BRACKET FOR PREFABRICATED WALL PANELS

(71) Applicant: A. RAYMOND ET CIE, Grenoble (FR)

(72) Inventors: Jason Reznar, Rochester Hills, MI (US); William Gregory Teller, Rochester Hills, MI (US); Justin McCullah, Rochester Hills, MI (US)

(21) Appl. No.: 18/221,580

(22) Filed: Jul. 13, 2023

(51) Int. Cl. E04G 21/14; B66C 1/62

(52) U.S. Cl. CPC E04G 21/142; B66C 1/62

(57) ABSTRACT

A lift nut mounting bracket for hoisting a building wall panel is provided. The lift nut mounting bracket includes a side plate and a top plate connected to the side plate at a first joint. The top plate includes a first opening therein. A receiving plate is connected to the top plate at a second joint. A receiver is formed in the receiving plate and is aligned with the first opening in the top plate. A nut is received and retained in the receiver. A plug may be inserted into the nut. A method of manufacturing a lift nut mounting bracket is also provided.

### FIELD OF THE INVENTION

The disclosure generally relates to mounting brackets and, more specifically, to mounting brackets for hoisting a prefabricated wall panel during installation of the wall panel on a building and for hoisting and placing prefabricated panels within an offsite facility to construct volumetric modules.

### BACKGROUND OF THE INVENTION

It is known in modern building construction (both residential and commercial) to prefabricate/precast components of the building structure such as wall panels, roof panels, floor modules, and the like at an offsite location ahead of their installation in the building structure. Such prefabrication provides certain efficiencies including both a cost and time savings as time is not spent on the jobsite constructing the building components, and the components can be made in batches at the offsite location such as a factory or other manufacturing facility. Prefabricated construction also provides for the assembly of module and panel components in a controlled environment that enables better monitoring and enforcement of quality control. Common prefabricated building applications include single-detached homes, apartments, office spaces, schools, temporary construction facilities, medical camps, and evacuation centers, to name a few.

One example of prefabricated (“prefab”) building components utilized in modern construction are prefab exterior wall panels. These exterior wall panels can be formed on a metal frame such as a steel or aluminum frame, and may include sheathing, air and moisture barrier(s), continuous insulation, and/or outer façade aesthetics. The prefab exterior wall panels can be made in various sizes but typically are about 14 to 16 feet wide and 40 to 50 feet in length in order to fit on a flatbed semi-truck and trailer for transportation from the manufacturing facility to a construction site. The prefab exterior wall panels also may range in weight from a “lightweight” of around 5,000 pounds to a “heavyweight” of around 12,000 pounds.

In order to install the heavy prefab exterior wall panels onto the exterior of a building under construction, the wall panels are hoisted by a crane or similar by connecting the hooks at the end of the crane's hoist rope to the top of the wall panels. Lifting brackets are mounted onto the wall panels, and eyelet bolts are attached to the mounting brackets for connection to the crane hooks. Depending on the weight of one of the wall panels, two to four lifting brackets are required per panel to safely lift the panel off the ground. Typically, the lifting brackets are thick metal, L-shaped brackets onto each of which a large nut is welded for attaching the eyelet bolt. The lifting brackets are commonly fabricated on site by welding tradesmen, which is expensive and time consuming. Therefore, a need exists for a wall panel lifting bracket that can be more easily mass produced at a lower cost prior to its use at a construction site.

Furthermore, once a wall panel is lifted as described above and installed into place on a building under construction, the eye bolts are removed from the brackets, leaving openings (one per lifting bracket) on top of the wall panel through which water or other objects may undesirably penetrate to the inside of the panel. Therefore, these openings must be closed and made water resistant. Typically, fiberglass is placed into each opening and a coating is applied over the opening and fiberglass. This sealing process for the openings adds time and cost to the installation of the wall panel.

### BRIEF SUMMARY

An improved lift nut mounting bracket for hoisting a building wall panel is provided. The lift nut mounting bracket may provide one or more of the following advantages: elimination of welding to fabricate the bracket, reduced cost of assembly, reduced labor and time, both to fabricate the bracket and to install the bracket, and ability of the customer to directly purchase the fabricated bracket for immediate use, rather than to hire labor to fabricate brackets at a construction site. The lift nut mounting bracket includes a side plate and a top plate connected to the side plate at a first joint. The top plate includes a first opening therein. A receiving plate is adjacent the top plate. A receiver is formed in the receiving plate and is aligned with the first opening in the top plate. A nut is received and retained in the receiver.

In specific embodiments, the receiving plate is connected to the top plate at a second joint.

In specific embodiments, the receiver is an opening having a shape that corresponds to the cross-sectional shape of the nut.

In particular embodiments, the receiver opening has a hexagonal shape.

In specific embodiments, the receiving plate is spaced from and overlaps the top plate.

In specific embodiments, the side plate is generally perpendicular to the top plate.

In specific embodiments, the side plate includes a plurality of apertures for attaching the mounting bracket on a frame member of a wall panel.

In specific embodiments, the lift nut mounting bracket further includes at least one tab protrusion extending from the side plate. The at least one tab protrusion contacts the receiving plate and restricts movement of the receiving plate in a direction away from the top plate.

In specific embodiments, the side plate, top plate, and receiving plate are monolithic in construction.

In specific embodiments, lift nut mounting bracket is formed of metal, a high-strength low-alloy (HSLA) steel.

In specific embodiments, the lift nut mounting bracket further includes a retaining tab connected to the side plate at a third joint. The retaining tab includes a second opening therein. The retaining tab secures the nut in the receiver, the first opening is aligned with the second opening, and the first and second openings overlap the receiver.

In particular embodiments, the second opening in the retaining tab generally corresponds in size and shape to an internal threaded bore of the nut.

In particular embodiments, the retaining tab overlaps the receiving plate and the top plate.

In particular embodiments, the retaining tab extends from the side plate.

In particular embodiments, the side plate, top plate, receiving plate, and retaining tab are monolithic in construction.

In specific embodiments, the nut includes a flange that retains the nut in the receiver.

In specific embodiments, the receiving plate is separate from the side plate and the top plate.

In certain embodiments, the side plate and the top plate are monolithic in construction, and the receiving plate is formed separate from the side plate and the top plate.

In specific embodiments, the receiving plate includes a plurality of raised circular surfaces.

In specific embodiments, a plug is inserted into the nut.

In particular embodiments, the plug includes a longitudinally extending shaft cooperable with threads of an internal threaded bore of the nut.

In certain embodiments, the shaft includes a plurality of lamella that interlock with the threads of the nut.

In particular embodiments, the plug includes a flexible umbrella cap on one end of the shaft, the umbrella cap having an outer perimeter.

In certain embodiments, the umbrella cap includes an outwardly and downwardly extending annular ring within the outer perimeter.

In particular embodiments, the shaft includes an outwardly extending annular flange.

In other embodiments of the disclosure, the lift nut mounting bracket includes a single metal piece. The single metal piece forms a side section for connection to a frame of a wall panel. The single metal piece also forms a top section that merges into the side section via a first bending section that is bent around a first bending axis. The top section, the first bending section, and the side section form an angle of approximately 90 degrees. The top section includes a first opening. The single metal piece also forms a folded receiving section that merges into the top section via a second bending section that is bent around a second bending axis. The receiving section, the second bending section, and the top section form an angle of approximately 180 degrees. A receiver is formed in the receiving section, and the receiver overlaps the first opening in the top section. A nut is received and retained in the receiver.

In specific embodiments, the receiving section overlaps the top section and is spaced from the top section.

In specific embodiments, the side section is generally perpendicular to the top section.

In specific embodiments, the first and second bending axes are generally parallel to each other, and the first and second bending axes are generally perpendicular to a longitudinal axis of the metal piece.

In specific embodiments, the lift nut mounting bracket further includes at least one tab protrusion extending from the side plate. The at least one tab protrusion contacts the receiving plate and restricts movement of the receiving plate in a direction away from the top plate.

In specific embodiments, the single metal piece also forms a retaining tab section that merges into the side section via a third bending section that is bent around a third bending axis. The retaining tab section, the third bending section, and the side section form an angle of approximately 90 degrees. The third bending section is formed in the side section. The retaining tab section extends from the side section, and the retaining tab section includes a second opening that is aligned with the first opening in the top section.

In particular embodiments, the first, second, and third bending axes are generally parallel to each other, and the first, second, and third bending axes are generally perpendicular to a longitudinal axis of the metal piece.

In particular embodiments, the retaining tab section secures the nut in the receiver, and the retaining tab section overlaps the receiving section and the top section.

A method of manufacturing a lift nut mounting bracket is also provided. The method includes providing a single metal piece. The method also includes forming a receiver and a first circular opening in the single metal piece. The receiver and the first circular opening are generally aligned along a longitudinal axis of the single metal piece. The method further includes bending the single metal piece along a first bending axis positioned opposite the receiver relative to the first circular opening to form a side section that is continuous with and merges with a top section. The method further includes bending the single metal piece along a second bending axis positioned between the first circular opening and the receiver to form a receiving section that is continuous with and merges with the top section. The receiving section is folded over the top section, and the receiving section overlaps and is spaced from the top section.

In specific embodiments, the single metal piece has an inner face, an opposite outer face, and a peripheral edge at an end thereof. The peripheral edge contacts the inner face after bending the single metal piece along the second bending axis to form the receiving section.

In specific embodiments, the method additionally includes the steps of disposing a nut in the receiver.

In specific embodiments, the first bending axis and the second bending axis are generally perpendicular to the longitudinal axis, and the first and second bending axes are generally parallel to each other.

In specific embodiments, the method further includes the step of forming a second circular opening in the single metal piece, wherein the receiver, the first circular opening, and the second circular opening are generally aligned along the longitudinal axis of the single metal piece. The method additionally includes the step of forming a retaining tab section that surrounds the second circular opening. The retaining tab section is formed as a cutout in the single metal piece, and only one edge of the retaining tab section is continuous with the single metal piece.

In particular embodiments, the method further includes the steps of disposing a nut in the receiver, and bending the retaining tab section along a third bending axis to secure the nut in the receiver. The third bending axis is formed along the said only one edge of the retaining tab section.

In particular embodiments of the method, the first bending axis, the second bending axis, and the third bending axis are generally perpendicular to the longitudinal axis, and the first, second, and third bending axes are generally parallel to each other.

In particular embodiments, the single metal piece has an inner face, an opposite outer face, and a peripheral edge at an end thereof. The method additionally includes the step of bending the retaining tab section along a third bending axis. The third bending axis is formed along the said only one edge of the retaining tab section, and the retaining tab section is bent in a direction faced by the inner face of the single metal piece and away from a direction faced by the outer face of the single metal piece.

### DESCRIPTION OF THE DRAWINGS

Various advantages and aspects of this disclosure may be understood in view of the following detailed description when considered in connection with the accompanying drawings, wherein:

FIG. 1 is a front perspective view of a lift nut mounting bracket in accordance with some embodiments of the disclosure;

FIG. 2 is a rear perspective view of the lift nut mounting bracket of FIG. 1;

FIG. 3A is a perspective view of a nut and a metal piece of the lift nut mounting bracket of FIG. 1;

FIG. 3B is a perspective view of the nut being inserted into a receiver of the lift nut mounting bracket;

FIG. 3C is a perspective view of the nut fully inserted into the receiver;

FIG. 3D is a perspective view of the nut being secured in the receiver by a retaining tab of the lift nut mounting bracket;

FIG. 4 is a perspective view of the lift nut mounting bracket shown in FIG. 1 connected to a frame of an exterior wall panel, with an eyelet bolt attached the a nut of the mounting bracket;

FIG. 5 is a front perspective view of a lift nut mounting bracket in accordance with other embodiments of the disclosure;

FIG. 6 is a rear perspective view of the lift nut mounting bracket of FIG. 5;

FIG. 7 is a front cross-sectional view of the lift nut mounting bracket of FIG. 5;

FIG. 8 is front perspective view of a lift nut mounting bracket in accordance with yet other embodiments of the disclosure;

FIG. 9 is a rear perspective view of the lift nut mounting bracket of FIG. 8;

FIG. 10 is a front cross-sectional view of the lift nut mounting bracket of FIG. 8;

FIG. 11 is a side cross-sectional view of the lift nut mounting bracket of FIG. 8;

FIG. 12 is a perspective view of a receiving plate of the lift nut mounting bracket of FIG. 8;

FIG. 13 is a perspective view of a plug that fits into the nut of the mounting bracket;

FIG. 14 is a side view of the plug of FIG. 13;

FIG. 15 is a front view of the plug of FIG. 13;

FIG. 16 is a sectional view of the plug of FIG. 13 inserted into the mounting bracket and through a hole in the exterior wall panel left open when the eyelet bolt is removed; and

FIG. 17 is a perspective view of the plug of FIG. 13 inserted through the hole and into the mounting bracket.

### DETAILED DESCRIPTION OF THE INVENTION

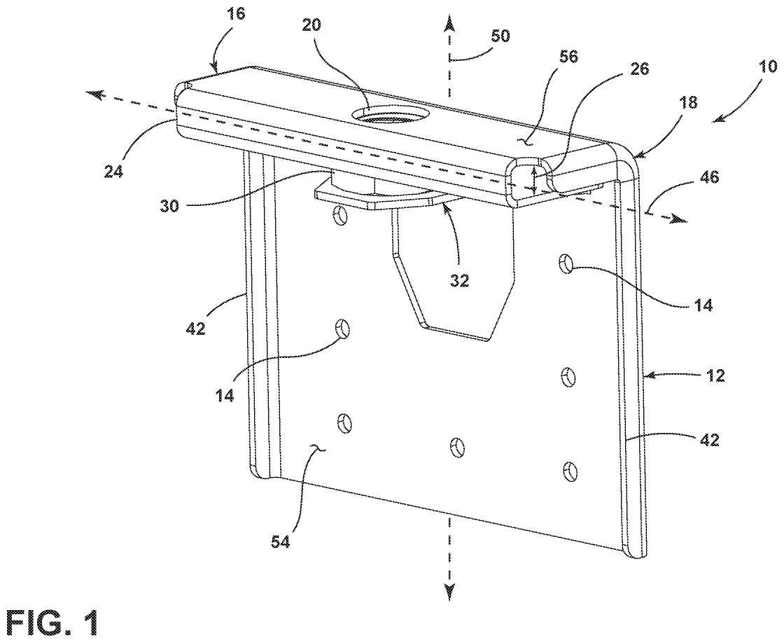

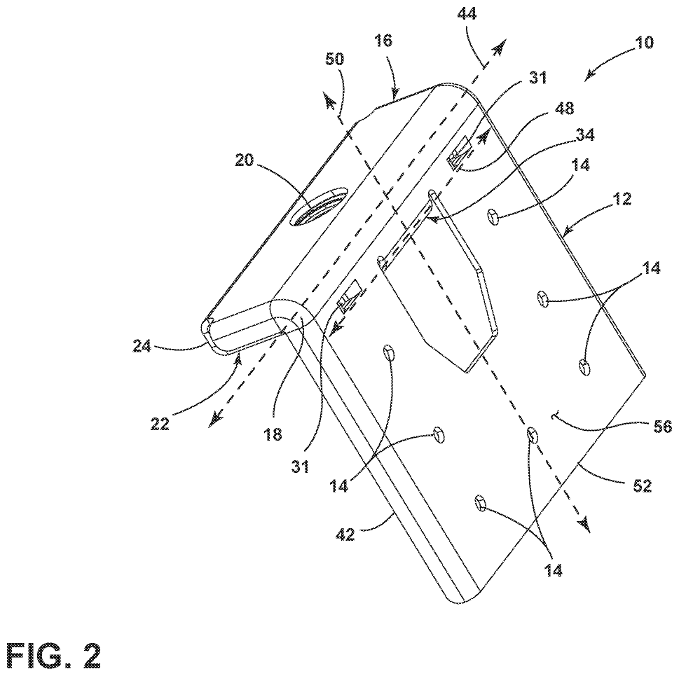

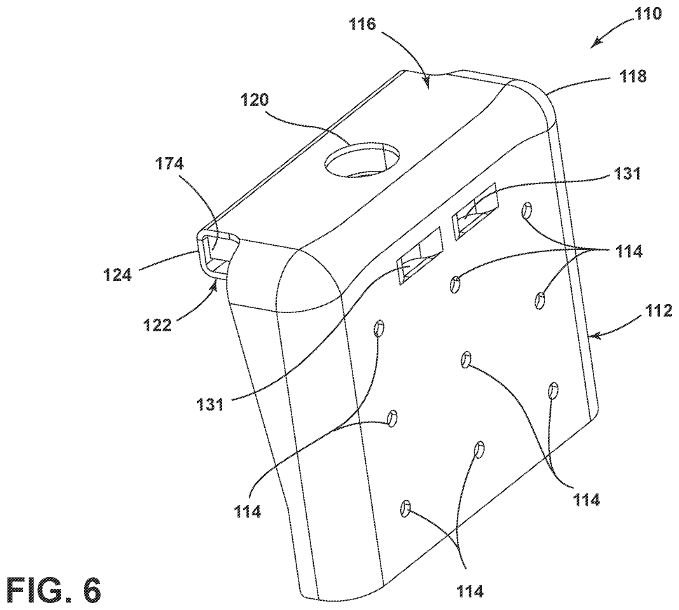

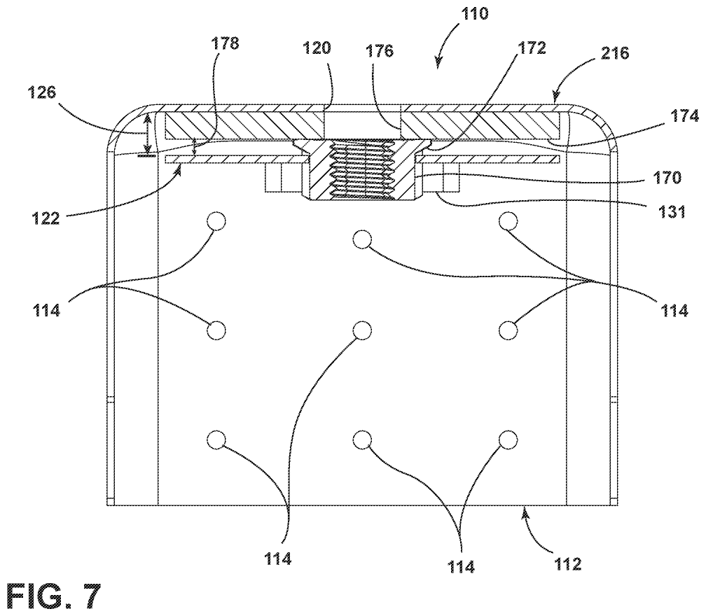

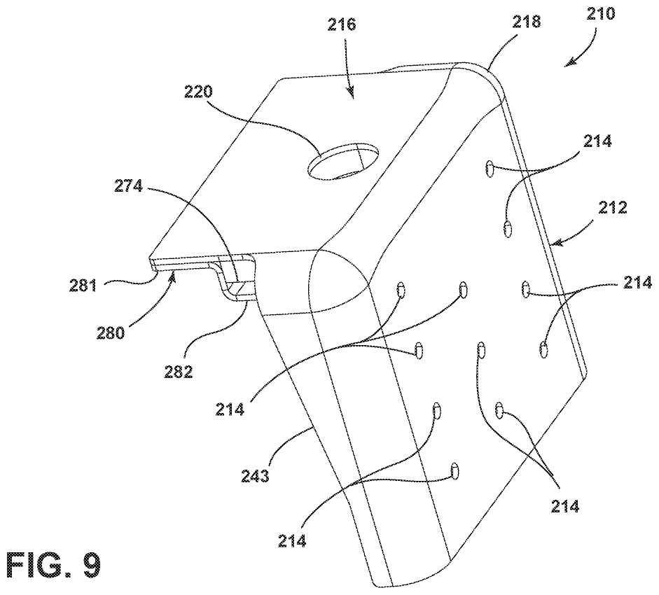

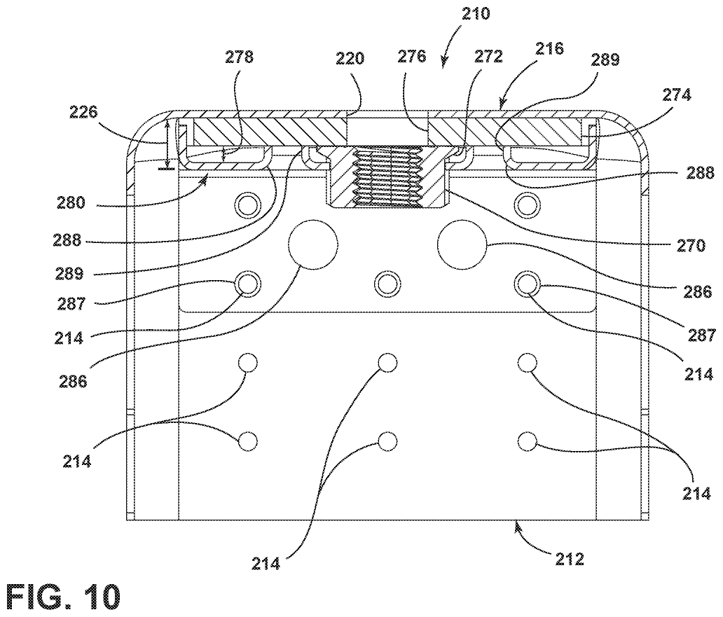

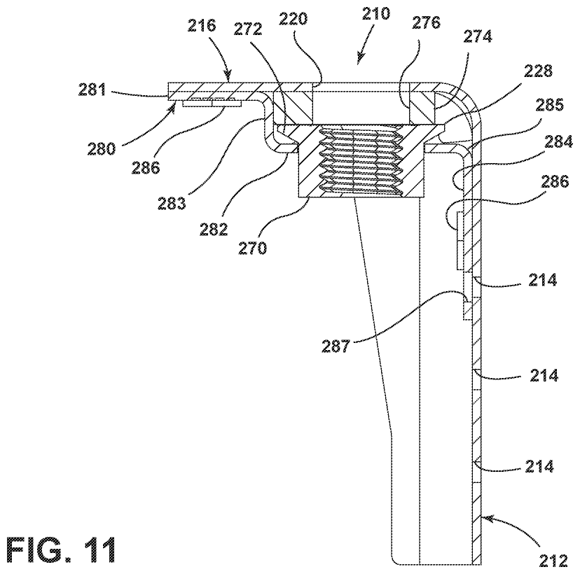

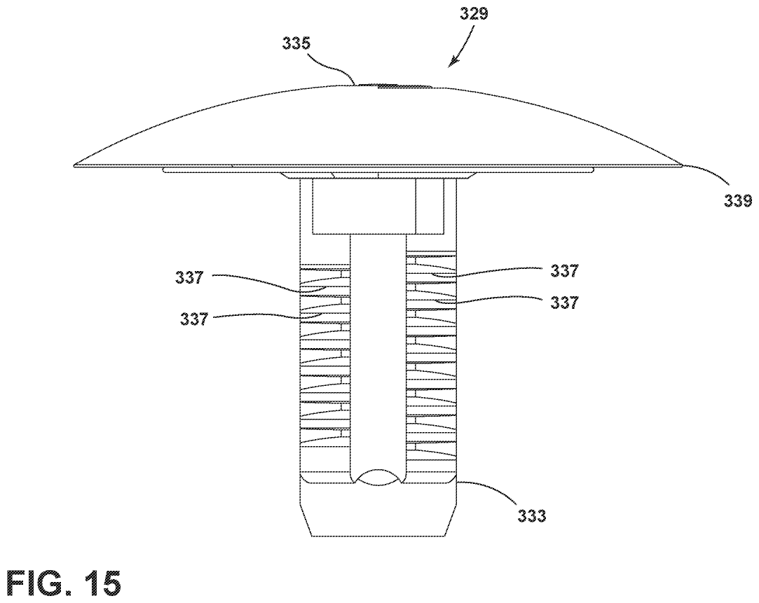

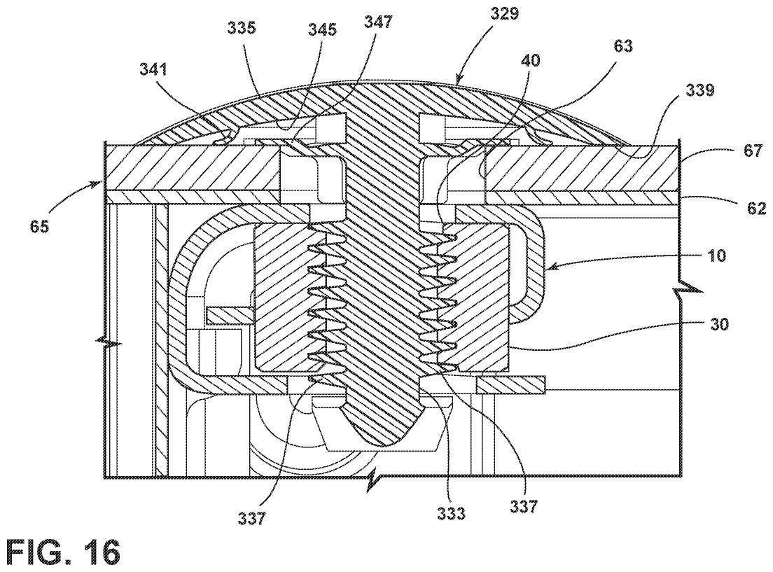

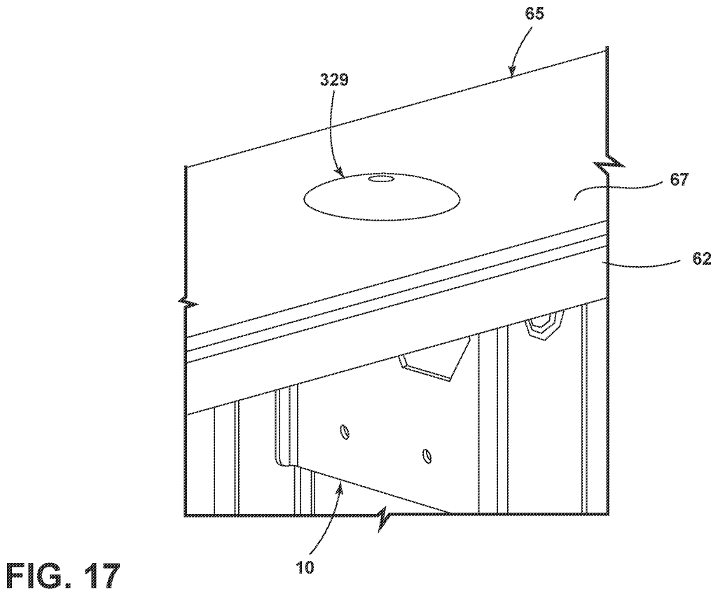

A lift nut mounting bracket is provided. Referring to FIGS. 1-17, wherein like numerals indicate corresponding parts throughout the several views, the lift nut mounting bracket (also referred to as mounting bracket herein) is illustrated an generally designated at 10, 110, 210. Certain features of the lift nut mounting bracket 10, 110, 210 are functional, but can be implemented in different aesthetic configurations.

Turning first to FIGS. 1-3D, in some embodiments the mounting bracket 10 includes a side (backing) plate 12 for connection of the mounting bracket to a structural frame of a wall panel, such as the upper sill and/or a vertical stud of the frame. The wall panel may be a prefab exterior wall panel including a steel frame, sheathing, air and moisture barriers, continuous insulation, and/or an exterior façade aesthetic. Alternatively or in addition, the exterior wall panel may include a concrete layer which may or may not correspond to the exterior façade. The side plate 12 may be generally square in shape, but is not limited to a particular shape and may be, for example, rectangular or another polygonal shape. The side plate 12 includes a plurality of apertures 14 for attaching the mounting bracket 10 onto the frame of the wall panel. The apertures 14 are sized so that screws or other similar fasteners may be inserted through the apertures and into the frame structure of the wall panel.

A top plate 16 is connected to the side plate 12 at a first joint 18. The side plate 12 is generally perpendicular to the top plate 16. Particularly, the side plate 12 and top plate 16 preferably form an angle of 90 degrees, however the angle does not have to be precisely a right angle and may range, for example, between 85 and 95 degrees. The top plate 16 may be generally rectangular in shape, but is not limited to a particular shape and may be, for example, square in shape. The top plate 16 includes a first opening 20 formed within its boundaries that extends through the top plate from an inner face to an outer face. The first opening 20 is preferably circular, but is not limited to a circular shape and may be, for example, a square or other polygonal shape. As described in more detail below, the first opening 20 should be sized and shaped such that the shaft of an eyelet bolt or similar can pass through the first opening.

A receiving plate 22 is connected to the top plate 16 at a second joint 24. The receiving plate 22 is generally folded over the top plate 16 such that there is approximately a 180 degree angle between the receiving plate and the top plate at the second joint 24, i.e. the receiving plate and top plate may lie in generally parallel planes. However, the angle between the receiving plate 22 and top plate 16 may not be precisely 180 degrees, and may be, for example, between 170 and 190 degrees such that the receiving plate and top plate are slightly out of plane. The receiving plate 22 is spaced from the top plate 16 such that there is a gap 26 between the receiving plate and the top plate. As will be more apparent below, the gap 26 preferably has a length that is less than the length of a nut (i.e., the length of the nut in the longitudinal direction of its internal bore). The receiving plate 22 also overlaps the top plate 16 such that the receiving plate may have a shape that generally corresponds in size in shape to the top plate. For example, the receiving plate 22 may also have a generally rectangular shape, although it should be understood that the receiving plate does not have to exactly match the size and shape of the top plate 16. The receiving plate 22 is secured in place against the side plate 12 by one or more tab protrusions 31 that extend outwardly from the surface of the side plate. A receiver 28 is formed in the receiving plate 22 and extends through the receiving plate from an inner face to an outer face. The receiver 28 is aligned with the first opening 20 in the top plate 16 such that the shaft of an eyelet bolt or similar can simultaneously pass through both the first opening and the receiver. The receiver 28 is an opening having a size and shape that is adapted to receive a nut 30, i.e. the receiver opening has a shape that corresponds to the cross-sectional shape of the nut. For example, the receiver opening 28 has a hexagonal shape that corresponds to the hexagonal outer surface of the nut 30. The nut 30 is received in the receiver 28, thereby extending into the gap 26 and resting against the inner surface of the top plate 16. Due to the length of the gap 26, the nut 30 may extend slightly out of the receiver 28 such that the outer surface (side walls) of the nut is held against the edges of the receiver opening. The nut may be formed of steel.

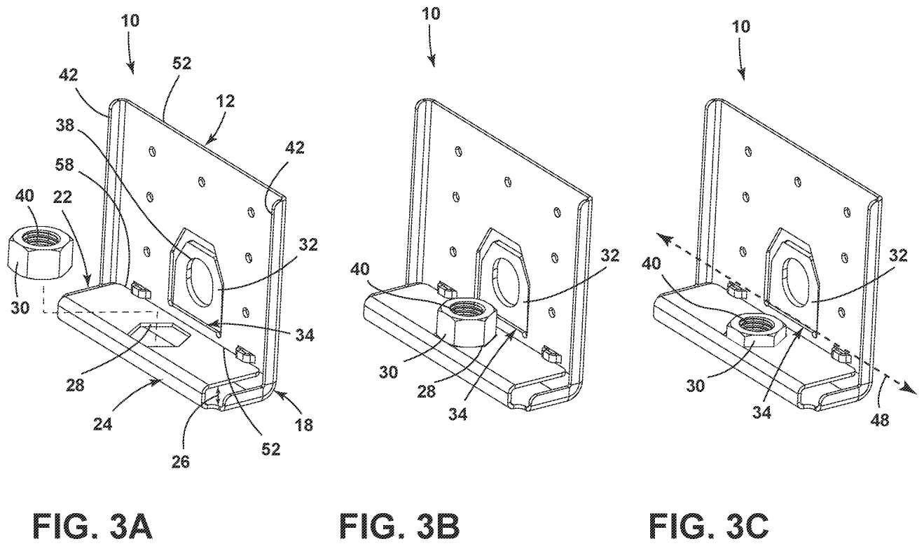

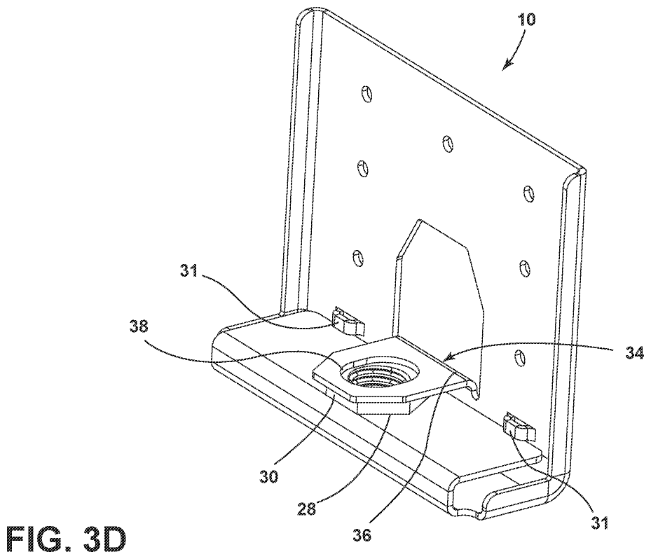

A retaining tab 32 is connected to the side plate 12 at a third joint 34. The retaining tab 32 may be a cut-out in the side plate 12 such that only one edge 36 of the retaining tab (at third joint 34) is connected to the side plate and the retaining tab is thus cantilevered relative to the side plate. Alternatively, the retaining tab 32 may be a separate piece that is welded to the side plate 12 at the third joint 34. The retaining tab 32 is not limited to a particular shape and may have an irregular polygonal shape as shown in FIG. 3D that is wider at the third joint 34 and tapers from the third joint towards the free end. The retaining tab 32 should at least have a shape that is sufficient to cover over the nut 30 in the receiver 28 as described in more detail below. The retaining tab 32 includes a second opening 38 formed within its boundaries that extends through the retaining tab from an inner face to an outer face. The second opening 38 is preferably a round circular or oval shape, but is not limited to a round or oval shape and may be, for example, a stadium (rectangle with two rounded or semi-circular opposite sides), square or other polygonal shape. As described in more detail below, the second opening 38 should be sized and shaped such that the shaft of an eyelet bolt or similar can pass through the second opening. The second opening 38 in the retaining tab 32 also may generally correspond in size and shape to an internal threaded bore 40 of the nut 30. The second opening 38 is illustrated in FIG. 3D by example as having an oval-like stadium shape that has two parallel sides with semi-circular ends in which the parallel sides are as far apart as the threaded bore of the nut, and the semi-circular ends are slightly wider than the threaded bore. When the nut 30 is properly disposed in the receiver 28, the retaining tab 32 is made to overlap the receiving plate 22 and the top plate 16, with the retaining tab extending outwardly from the side plate 12. The retaining tab 32 is positioned on the side plate 12 such that when the retaining tab is disposed over the nut 30, the retaining tab is generally perpendicular (preferably 90 degrees, but within a range of, for example, 85 to 95 degrees) to the side plate such that the retaining tab generally lies flush against the nut. In this configuration, the retaining tab 32 contacts and covers over the nut 30 to secure the nut in the receiver 28. Further, in this configuration the first opening 20 in the top plate 16 is aligned with the second opening 38 in the retaining tab 32, and the first and second openings overlap the receiver 28 in the receiving plate 22. Therefore, the shaft of an eyelet bolt or similar may be inserted into the first opening 20 in the top plate 16, threaded into the inner threaded bore 40 of the nut 30 secured in the receiver 28, and inserted through the second opening 38 in the retaining tab 32.

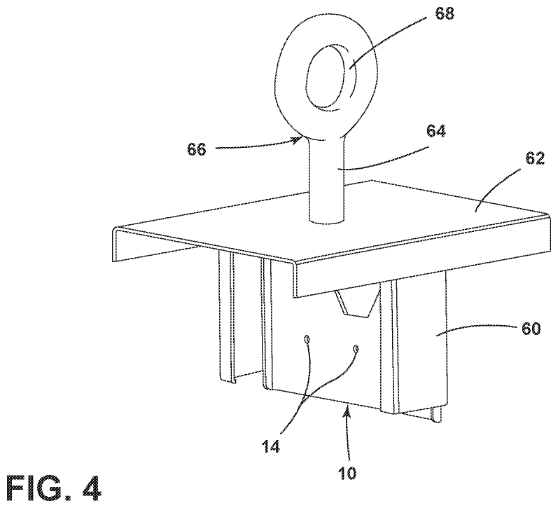

The mounting bracket 10 may include flanged outer edges 42 on the two lateral sides of the mounting bracket. The flanged outer edges 42 can aid in placing and positioning the mounting bracket 10 within a vertical stud and upper sill of an exterior wall frame as shown by example in FIG. 4 and described in more detail below.

The mounting bracket 10 may be formed of metal such as a high-strength low-alloy (HSLA) steel. Particularly, the side plate 12, the top plate 16, the receiving plate 22, and the retaining tab 32 may be made of HSLA steel. The nut 30 may also be made of steel, such as HSLA steel, or any other metal suitable for the nut. HSLA steel provides better mechanical properties (e.g., strength, toughness) than other steel such as carbon steel, has a higher corrosion resistance, and has a greater strength-to-weight ratio. HSLA steel does not have a specific chemical composition (rather it is made to meet specific mechanical properties), but typically includes carbon in an amount between 0.05 and 0.25% and alloying elements such as up to 2.0% manganese and small quantities (e.g. less than 2.0%, less than 1.5%, less than 1.0%, less than 0.5%, less than 0.1%) of copper, nickel, niobium, nitrogen, vanadium, chromium, molybdenum, titanium, calcium, rare-earth elements, zirconium, manganese, phosphorus, sulfur, and/or silicon to produce a fine dispersion of alloy carbides in a nearly pure ferrite (iron) matrix.

While the mounting bracket 10 may be formed from a plurality of pieces that are, for example, welded together, in specific embodiments the mounting bracket is primarily constructed from a single metal piece. With the exception of the nut 30, the components of the mounting bracket (side plate 12, top plate 16, receiving plate 22, retaining tab 32) in these specific embodiments are monolithic in construction and formed of the single metal piece. Particularly, a side section of the single metal piece defines the side plate 12, a top section of the single metal piece defines the top plate 16, a folded receiving section of the single metal piece defines the receiving plate 22, and a retaining tab section of the single metal piece defines the retaining tab 32. The top section 16 merges into the side section 12 via a first bending section that defines the first joint 18 and is bent around a first bending axis 44. Rather than a permanent weld, the first joint/first bending section 18 is a continuous union between the top section 16 and the side section 12. The top section 16, the first bending section 18, and the side section 12 form an angle of approximately 90 degrees (e.g., optionally between 85 and 95 degrees) such that the side section is generally perpendicular to the top section. The top section 16 includes the first opening 20. The folded receiving section 22 merges into the top section 16 via a second bending section that defines the second joint 24 and is bent around a second bending axis 46. Rather than a permanent weld, the second joint/second bending section 24 is a continuous union between the top section 16 and the folded receiving section 22. The receiving section 22, the second bending section 24, and the top section 16 form an angle of approximately 180 degrees (e.g., optionally between 170 and 190 degrees) such that the receiving section is folded over and overlaps the top section, and is also spaced from the top section. The receiver 28 is formed in the folded receiving section 22. The retaining tab section 32 merges into the side section 12 via a third bending section that defines the third joint 34 and is bent around a third bending axis 48. The third bending axis 48 is formed along the only end edge 36 of the retaining tab section 32 that remains connected to the side section 12. Rather than a permanent weld, the third joint/third bending section 34 is a continuous union between the side section 12 and the retaining tab section 32. In the configuration in which the retaining tab section 32 overlaps the receiving section 22 and top section 16 to secure the nut 30 in the receiver 28, the retaining tab section, the third bending section 34, and the side section 12 form an angle of approximately 90 degrees (e.g., optionally between 85 and 95 degrees). The third bending section 34 is generally formed in the side section 12 due to the retaining tab section 32 being cut out of the side section, and the retaining tab section extends from the side section. The retaining tab section 32 includes the second opening 38.

The single metal piece that forms the mounting bracket 10 in these embodiments has a longitudinal axis 50 that extends through the longitudinal ends 52 of the single metal piece forming the mounting bracket. The receiver 28 and first and second openings 20, 38 may be generally aligned along the longitudinal axis 50. The first bending axis 44, the second bending axis 46, and the third bending axis 48 may be generally parallel to each other, and the first, second, and third bending axes may be generally perpendicular to the longitudinal axis 50.

As shown in FIGS. 3A-D, a method of manufacturing the mounting bracket 10 includes providing a single metal piece as described above and forming the receiver 28, the first opening 20, and the second opening 38 in the single metal piece. The single metal piece may be, for example, a generally rectangular sheet of metal material such as an HSLA steel having a certain thickness that allows the single metal piece to be bent. The single metal piece has an inner face 54, an outer face 56, and a peripheral edge 58 at a longitudinal end 52 of the single metal piece. The receiver 28, the first opening 20, and the second opening 38 are formed such that they are generally aligned along the longitudinal axis 50 of the single metal piece. The retaining tab section 32 is also formed in the single metal piece, as a cutout in the single metal piece that surrounds the second opening 38. Only the one edge 36 of the retaining tab section 32 remains continuous with the single metal piece after forming the cutout that defines the retaining tab section 32. The single metal piece is bent along the first bending axis 44, which is disposed between the retaining tab section 32 and the first opening 20 to form the side section 12 that is continuous with and mergers with the top section 16. The single metal piece is also bent along the second bending axis 46, which is disposed between the first opening 20 and the receiver 28 to form the receiving section 22 that is continuous with and merges with the top section 16. The receiving section 22 is generally bent 180 degrees so that it is folded over the top section 16 and overlaps and is spaced from the top section. After bending the single metal piece along the second bending axis 46, the peripheral edge 58 of the single metal piece may contact the inner face 54 of the single metal piece. The order of bending is not particularly limited, and it should be understood that the single metal piece may be first bent along the second bending axis 46 to form the receiving section 22, and subsequently bent along the first bending axis 44 to form the top section 16 and side section 12.

After formation of the mounting bracket 10, the nut 30 is disposed in the receiver 28. Next, the retaining tab section 32 is bent along the third bending axis 48, thereby moving the retaining tab section from a configuration in which it is generally flush with the side section 12 to a configuration in which the retaining tab section 32 is bent generally 90 degrees relative to the side section to secure the nut 30 in the receiver 28. The retaining tab section 32 is bent in a direction faced by the inner face 54 of the single metal piece and away from a direction faced by the outer face 56 of the single metal piece.

In use one or more (e.g., two to four) mounting brackets 10 are installed on the exterior wall panel for the purpose of hoisting and positioning the exterior wall panel in a desired location of a building. Preferably, for efficiencies of cost and time, the mounting brackets 10 are installed on the wall panel offsite during fabrication of the wall panel, typically at the same facility at which the wall panel is fabricated. However, it should be understood that the mounting bracket 10 may be installed at another facility separate from the facility at which the panel is fabricated, or even installed on the construction site at which the wall panel is to be incorporated into a building structure. As shown in FIG. 4, each mounting bracket 10 may be positioned against a vertical stud of the exterior wall frame and up against the upper sill of the exterior wall frame. Particularly, the side section 12 of the mounting bracket 10 may be abutted against the beam of the vertical stud 60, and the top section 16 of the mounting bracket may be abutted against an inner surface of the upper sill 62. The flanged edges 42 of the mounting bracket 10 may press against edges of the vertical stud 60. Screws or other suitable fasteners (not shown) are drilled through the apertures 14 in the side section 12 to attach the mounting bracket 10 to the stud of the exterior wall frame. A through hole can be made in the upper sill or may already be present in the upper sill at a location that is aligned with the first opening 20 in the top section 16 of the mounting bracket 10. The shaft 64 of an eyelet bolt 66 can be inserted through the through hole in the upper sill 62, and through the first opening 20, the threaded internal bore 40 of the nut 30, and the second opening 38. Once the eyelet bolt 66 is secured into the mounting bracket 10, the hooks at the end of the hoist rope of a crane can be hooked to the eyelets 68 of the eyelet bolts 66. With the hoist rope properly hooked to the exterior wall panel, the crane can lift the exterior wall panel into the air and move it into position on the building.

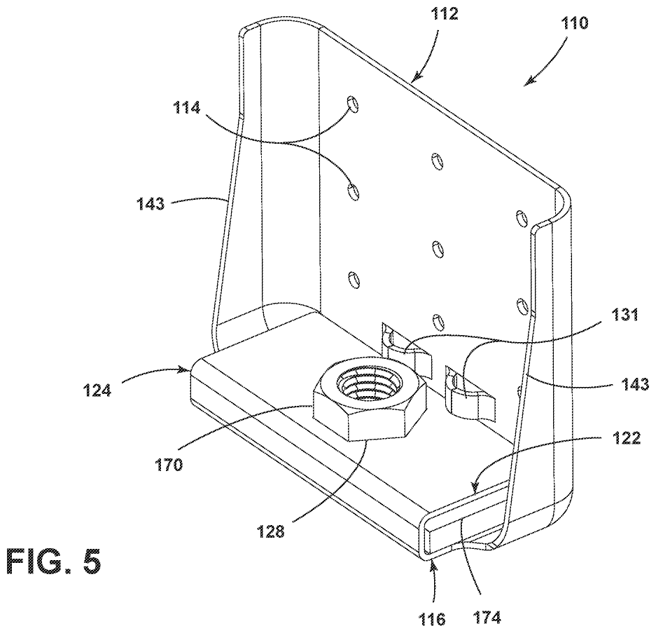

With reference now to FIGS. 5-7, in an alternative embodiment, the lift nut mounting bracket 110 does not include a retaining tab or other cut out in the side (backing) plate. Instead, the lift nut 170 includes a flange 172 that holds the lift nut in the receiver 128 and keeps the lift nut from passing through the receiver opening. Additionally, the mounting bracket 110 includes a support spacer 174 disposed between the top plate 116 and the receiving plate 122. The flange 172 of the lift nut 170 is adjacent a surface of the support spacer 174 and is sandwiched between the support spacer and the receiving plate 122. The mounting bracket 110 otherwise generally has the same or similar structure and construction as the mounting bracket 10, may be formed of an HSLA steel that is deep drawn and has a yield strength of at least 45 ksi and preferably at least 50 ksi, and may be utilized to lift a wall panel in the same way as the mounting bracket 10. Further, the nut 170 may be a ¾″ grade 8 steel nut.

More particularly, the mounting bracket 110 includes a side (backing) plate 112 for connection of the mounting bracket to a structural frame of a wall panel. The side plate 112 may be generally square in shape, but is not limited to a particular shape and may be, for example, rectangular or another polygonal shape. The side plate 112 includes a plurality of apertures 114 for attaching the mounting bracket 110 onto the frame of the wall panel. The apertures 114 are sized so that screws or other similar fasteners may be inserted through the apertures and into the frame structure of the wall panel. As shown, the mounting bracket 110 may include an array of nine apertures that are evenly spaced and arranged in a square pattern on the side plate 112. However, the side plate is not limited to a specific number of apertures or a specific spacing and arrangement of the apertures.

A top plate 116 is connected to the side plate 112 at a first joint 118. The side plate 112 is generally perpendicular to the top plate 116. Particularly, the side plate 112 and top plate 116 preferably form an angle of 90 degrees, however the angle does not have to be precisely a right angle and may range, for example, between 85 and 95 degrees. The top plate 116 may be generally rectangular in shape, but is not limited to a particular shape and may be, for example, square in shape. The top plate 116 includes a first opening 120 formed within its boundaries that extends through the top plate from an inner face to an outer face. The first opening 120 is preferably circular, but is not limited to a circular shape and may be, for example, a square or other polygonal shape.

A receiving plate 122 is connected to the top plate 116 at a second joint 124. The receiving plate 122 is generally folded over the top plate 116 such that there is approximately a 180 degree angle between the receiving plate and the top plate at the second joint 124, i.e. the receiving plate and top plate may lie in generally parallel planes. However, the angle between the receiving plate 122 and top plate 116 may not be precisely 180 degrees, and may be, for example, between 170 and 190 degrees such that the receiving plate and top plate are slightly out of plane. The receiving plate 122 is spaced from the top plate 116 such that there is a gap 126 between the receiving plate and the top plate. The gap 126 preferably has a length that is less than the length of a nut (i.e., the length of the nut in the longitudinal direction of its internal bore). The receiving plate 122 also overlaps the top plate 116 such that the receiving plate may have a shape that generally corresponds in size in shape to the top plate. For example, the receiving plate 122 may also have a generally rectangular shape, although it should be understood that the receiving plate does not have to exactly match the size and shape of the top plate 116. The receiving plate 122 is secured in place against the side plate 112 by one or more tab protrusions 131 that extend outwardly from the surface of the side plate 112. The tab protrusions 131 may be formed, for example, by a strip of curved or bent metal material that extends away from the side plate 112, such as away from a cutout in the side plate 112, and towards the receiver 128. In this embodiment of the bracket 110, the tab protrusions 131 are centrally disposed on the side plate 112 relative to the two flanged edges 143 on the sides of the side plate 112. Also, the tab protrusions 131 are proximate the receiver 128 and generally flank opposite sides of the receiver 128 in a direction perpendicular to the longitudinal axis of the bracket 110. The tab protrusions 131 contact a free edge of the receiving plate 112 and restrict bending movement of the receiving plate 122, such as if a force is applied normal to the surface of the receiving plate 122, for example by the flange 172 on the lift nut 170. Particularly, the tab protrusions 131 restrict movement of the receiving plate 122 in a direction away from the top plate 116.

A support spacer 174 is disposed in the gap 126 between the top plate 116 and the receiving plate 122. The support spacer 174 generally has a shape that corresponds to the shape of the top plate 116 and the receiving plate 122. For example, the support spacer 174 may be a rectangular-shaped solid that has a thickness less than the length of the gap 126 for reasons that will be more apparent below. For example, the support spacer 174 may have a thickness of 7.5 mm. The support spacer 174 includes a circular opening 176 that is aligned with the opening 120 in the top plate 116 and has a diameter that is at least as large as the diameter of the opening 120. In the embodiment shown, the circular opening 176 is larger than the opening 120. The support spacer may be formed of an HSLA steel that has a yield strength of at least 45 ksi and preferably at least 50 ksi.

A receiver 128 is formed in the receiving plate 122 and extends through the receiving plate from an inner face to an outer face. The receiver 128 is aligned with the first opening 120 in the top plate 116 and the circular opening 176 in the support spacer 174 such that the shaft of an eyelet bolt or similar can simultaneously pass through each of the first opening, the circular opening, and the receiver. The receiver 128 is an opening having a size and shape that is adapted to receive the nut 170, i.e. the receiver opening has a shape that corresponds to the cross-sectional shape of the sidewalls of the nut. For example, the receiver opening 128 has a hexagonal shape that corresponds to the hexagonal outer surface of the nut 170. The nut 170 is received in the receiver 128, thereby extending into the gap 126. Due to the length of the gap 126 and the width of the support spacer 174, the nut 170 may extend out of the receiver 128 such that the outer surface (side walls) of the nut is held against the edges of the receiver opening. The flange 172 at one end of the nut 170 extends laterally beyond the edges of the receiver opening and prevents the nut 170 from being removed from the receiver 128. In order to accommodate the flange 172 of the nut 170, a gap 178 exists between the support spacer 174 and the receiving plate 122 which is due to the fact that the thickness of the support spacer 174 is less than the length of the gap 126 between the top plate 116 and the receiving plate 122. The movement of the nut is constrained by the support spacer 174 and the receiving plate 122 which together sandwich the nut 170, and in one disposition the flange 172 of the nut may rest against the surface of the support spacer 174 and an inner surface of the receiving plate 122. Therefore, it is apparent that the support spacer must be disposed adjacent the inner surface of the top plate 116 and the nut 170 must be inserted into the receiver 128 prior to folding the receiving plate 122 towards the top plate 116.

The mounting bracket 110 may include flanged outer edges 143 on the two lateral sides of the mounting bracket. The flanged outer edges 143 can aid in placing and positioning the mounting bracket 110 within a vertical stud and upper sill of an exterior wall frame in the same way as the mounting bracket 10. However, the flanged outer edges 143 of the mounting bracket 110 are significantly greater in surface area than the edges 42 of the mounting bracket 10, and the flanged outer edges 143 may have a triangular or trapezoidal shape.

While the mounting bracket 110 may be formed from a plurality of pieces that are, for example, welded together, in specific embodiments the mounting bracket is primarily constructed from a single metal piece. With the exception of the nut 170 and support spacer 174, the components of the mounting bracket (side plate 112, top plate 116, receiving plate 122) may be monolithic in construction and formed of the single metal piece. Particularly, a side section of the single metal piece defines the side plate 112, a top section of the single metal piece defines the top plate 116, and a folded receiving section of the single metal piece defines the receiving plate 122. Rather than permanent welds, continuous unions exist between the sections of the mounting bracket. However, it should be understood that portions of the mounting bracket 110 (side plate 112, top plate 116, receiving plate 122) may be monolithic, whereas other portions such as the flanged outer edges 143, may be welded to the side plate 112 and top plate 116.

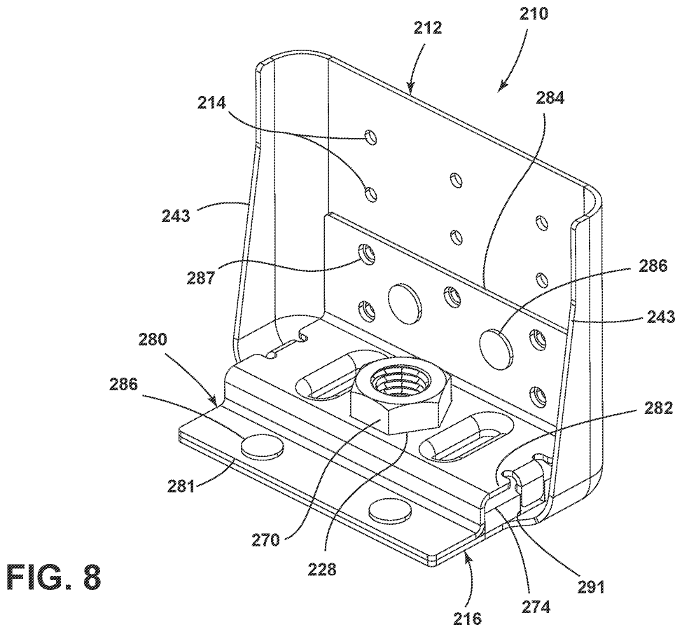

Turning next to FIGS. 8-12, in yet another alternative embodiment, the lift nut mounting bracket 210 includes a separate receiving plate 280 such that the bracket is not formed as a single piece. Similar to the first alternative embodiment 110, the second alternative embodiment 210 also includes a support space 274 disposed between the top plate 216 and the receiving plate 280. Also, the flange 272 of the lift nut 270 is adjacent a surface of the support spacer 274 and is sandwiched between the support spacer and the receiving plate 280. The mounting bracket 210 may be formed of an HSLA steel that is deep drawn and has a yield strength of at least 45 ksi and preferably at least 50 ksi, and may be utilized to lift a wall panel in the same way as the mounting bracket 10. Further, the nut 270 may be a ¾″ grade 8 steel nut.

More particularly, the mounting bracket 210 includes a side (backing) plate 212 for connection of the mounting bracket to a structural frame of a wall panel. The side plate 212 may be generally square in shape, but is not limited to a particular shape and may be, for example, rectangular or another polygonal shape. The side plate 212 includes a plurality of apertures 214 for attaching the mounting bracket 210 onto the frame of the wall panel. The apertures 214 are sized so that screws or other similar fasteners may be inserted through the apertures and into the frame structure of the wall panel. As shown, in this embodiment the mounting bracket 210 may include an array of eleven apertures including nine that are evenly spaced and arranged in a square pattern on the side plate 112 and an additional two apertures above and at the sides of the nine-aperture pattern. However, the side plate is not limited to a specific number of apertures or a specific spacing and arrangement of the apertures.

A top plate 216 is connected to the side plate 212 at a first joint 218. The side plate 212 is generally perpendicular to the top plate 216. Particularly, the side plate 212 and top plate 216 preferably form an angle of 90 degrees, however the angle does not have to be precisely a right angle and may range, for example, between 85 and 95 degrees. The top plate 216 may be generally rectangular in shape, but is not limited to a particular shape and may be, for example, square in shape. The top plate 216 includes a first opening 220 formed within its boundaries that extends through the top plate from an inner face to an outer face. The first opening 220 is preferably circular, but is not limited to a circular shape and may be, for example, a square or other polygonal shape.

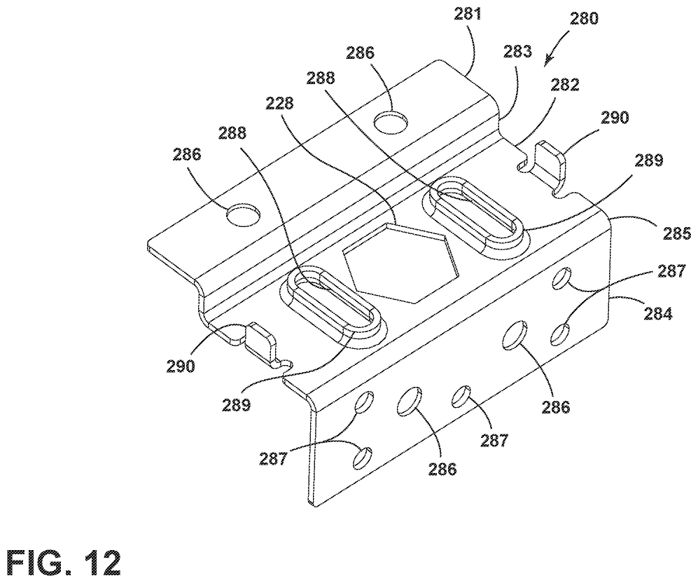

The receiving plate 280 is generally disposed adjacent the top plate 216 as well as the side plate 212 in the vicinity of the first joint 218. As shown in greater detail in FIG. 12, the receiving plate 280 generally has a right-angle or near-right-angle shape such that the receiving plate includes a first end portion 281 that is generally planar and abuts against the top plate 216, a central portion 282 that is offset from the first end portion 281 by an angular bend 283, and a second end portion 284 that is generally planar and abuts against the side plate 212. The second end portion 284 is generally perpendicular to the central portion 282 via a right-angle bend 285. However, it should be understood that the angle of the bend 285 should correspond to the angle between the top plate 216 and the side plate 212. The receiving plate 280 further includes a plurality of raised (e.g., stamped) surfaces 286 that aide in preventing against looseness that may occur during assembly. The surfaces 286 may be Tog-L-loc made with a tool. The first end portion 281 may include two symmetrically disposed raised surfaces 286 and the second end portion 281 may likewise include two symmetrically disposed raised surfaces 286. The second end portion 281 also includes a plurality of apertures 287 that align with some of the apertures 214 in the side plate 212 such that the receiving plate 280 may be secured to the side plate 212 during assembly. The receiving plate 280 is spaced from the top plate 216 such that there is a gap 226 between the receiving plate and the top plate. The gap 226 preferably has a length that is less than the length of a nut (i.e., the length of the nut in the longitudinal direction of its internal bore). The first end portion 281 and the central portion 282 of the receiving plate 280 overlap the top plate 216 such that the first end portion and the central portion may have a shape that generally corresponds in size in shape to the top plate. However, it should be understood that the first end portion 281 and central portion 282 do not have to exactly match the size and shape of the top plate 216.

A support spacer 274 is disposed in the gap 226 between the top plate 216 and the receiving plate 280. The support spacer 274 generally has a shape that corresponds to the shape of the top plate 216 and the central portion 282 of the receiving plate 280. For example, the support spacer 274 may be a rectangular-shaped solid that has a thickness less than the length of the gap 226. For example, the support spacer 274 may have a thickness of 7.5 mm. The support spacer 274 includes a circular opening 276 that is aligned with the opening 220 in the top plate 216 and has a diameter that is at least as large as the diameter of the opening 220. The support spacer 274 may be formed of an HSLA steel that has a yield strength of at least 45 ksi and preferably at least 50 ksi.

The central portion 282 of the receiving plate 280 has a pair of openings 288 that may be oval or oblong in shape and from the perimeter of which extend an annular flange 289. The outer edge of the annular flange 289 contacts the support spacer 274 to assure a tight fit between the receiving plate 280 and the support spacer 274. The central portion 282 of the receiving plate 280 further includes a pair of lateral flanges 290 at opposite lateral sides of the central portion. The lateral flanges 290 fit into lateral slots on opposite lateral sides of the support spacer 274 to align the support spacer with the receiving plate 280 and to limit relative movement between the support spacer and the receiving plate.

A receiver 228 is formed in the receiving plate 280 and extends through the receiving plate from an inner face to an outer face. The receiver 228 is aligned with the first opening 220 in the top plate 216 and the circular opening 276 in the support spacer 274 such that the shaft of an eyelet bolt or similar can simultaneously pass through each of the first opening, the circular opening, and the receiver. The receiver 228 is an opening having a size and shape that is adapted to receive the nut 270, i.e. the receiver opening has a shape that corresponds to the cross-sectional shape of the sidewalls of the nut. For example, the receiver opening 228 has a hexagonal shape that corresponds to the hexagonal outer surface of the nut 270. The nut 270 is received in the receiver 228, thereby extending into the gap 226. Due to the length of the gap 226 and the width of the support spacer 274, the nut 270 may extend out of the receiver 228 such that the outer surface (side walls) of the nut is held against the edges of the receiver opening. The flange 272 at one end of the nut 270 extends laterally beyond the edges of the receiver opening and prevents the nut 270 from being removed from the receiver 228. In order to accommodate the flange 272 of the nut 270, a gap 278 exists between the support spacer 274 and the receiving plate 280 which is due to the fact that the thickness of the support spacer 274 is less than the length of the gap 226 between the top plate 216 and the receiving plate 280. The movement of the nut is constrained by the support spacer 274 and the receiving plate 280 which together sandwich the nut 170, and in one disposition the flange 172 of the nut may rest against the surface of the support spacer 174 and an inner surface of the receiving plate 280 Therefore, it is apparent that the support spacer must be disposed adjacent the inner surface of the top plate 216 and the nut 270 must be inserted into the receiver 228 prior to connecting the receiving plate 280 to the top plate 216.

The mounting bracket 210 may include flanged outer edges 243 on the two lateral sides of the mounting bracket. The flanged outer edges 243 can aid in placing and positioning the mounting bracket 210 within a vertical stud and upper sill of an exterior wall frame in the same way as the mounting bracket 10. However, the flanged outer edges 243 of the mounting bracket 210 are significantly greater in surface area than the edges 42 of the mounting bracket 10, and the flanged outer edges 243 may have a triangular or trapezoidal shape.

While the side plate 212 and top plate 216 of the mounting bracket 210 may be formed from a plurality of pieces that are, for example, welded together, in specific embodiments these plates are primarily constructed from a single metal piece. The side plate 212 and top plate 216 may be monolithic in construction and formed of the single metal piece, while the receiving plate 280 is formed as a separate metal piece. Rather than permanent welds, continuous unions may exist between the side plate 212 and top plate 216. However, it should be understood that portions of the mounting bracket 210 (side plate 212, top plate 216) may be monolithic, whereas other portions such as the flanged outer edges 243, may be welded to the side plate 212 and top plate 216.

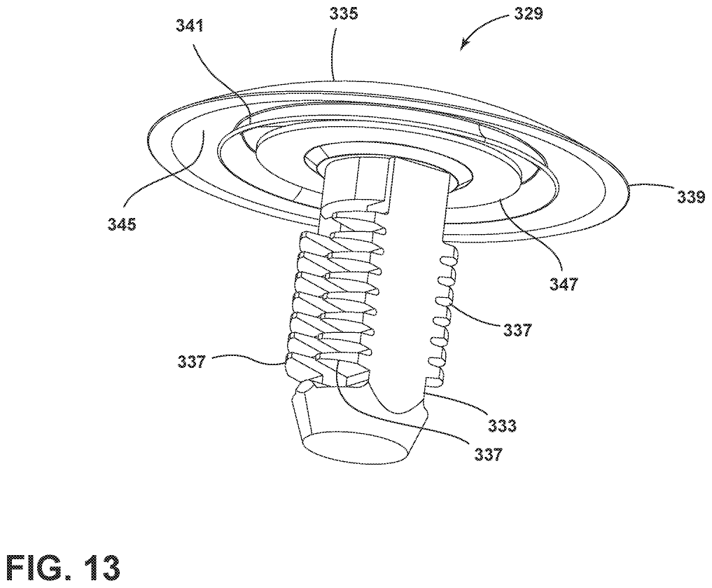

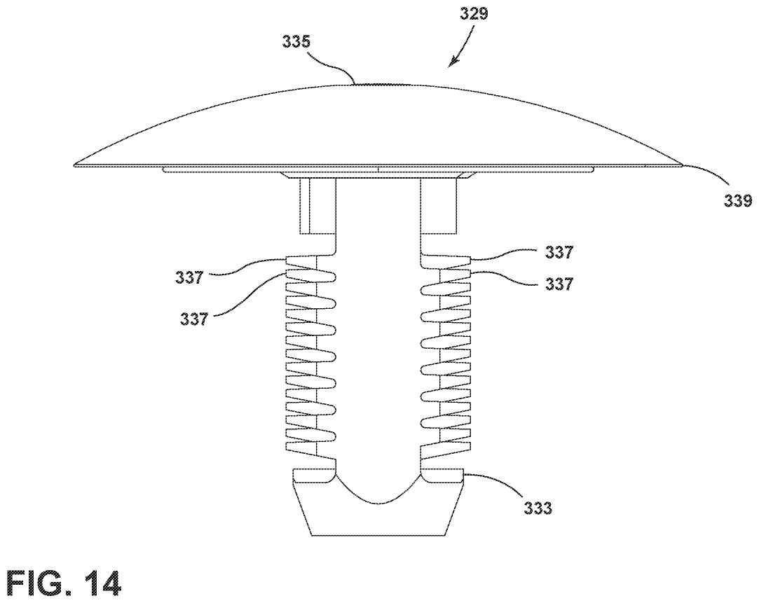

Turning next to FIGS. 13-17, once a prefabricated wall panel is lifted and installed into position on the exterior of a building as described above, each eyelet bolt 66 must be removed from the mounting bracket 10 (or mounting bracket 110 or mounting bracket 210, as the case may be). This procedure leaves an opening 63 in the top of the wall panel 65 through the upper sill 62 and gold coat 67 at the location in which the through hole was created to allow for the placement of the eyelet bolt into the mounting bracket. In order to quickly and easily seal the opening 63, a plug 329 is inserted through the opening 63 and into the threaded internal bore 40 of the nut 30. The plug 329 may be pushed into position by hand or with the aid of a hammer or other similar mechanical device. The plug 329 covers and seals the opening 63 to create a moisture barrier, and is much quicker and easier to install as opposed to plastering over the opening with material and adhesive. Thus, it is apparent that the plug 329 may be used in combination with the mounting bracket 10.

In one embodiment, the plug 329 includes a longitudinally extending shaft 333 and a flexible umbrella cap 335 disposed on one end of the shaft. The shaft 333 includes a plurality of lamella 337 that extend outwardly from side surfaces of the shaft. The lamellas 337 are cooperable with the threads of the threaded internal bore 40 of the nut 30 and interlock with the threads to hold the plug 329 in place within the nut and in the opening 63 in the upper surface of the wall panel 65. The lamellas 337 are a collection of thin, plate-like projections that are formed proximate to each other. The lamellas 337 may be disposed on opposite sides of the shaft 333 and arranged in an alternating step pattern along the longitudinal height direction of the shaft such that a lamella on one side of the shaft is disposed at a height that is between the height of two adjacent lamellas on the opposite side. In other words, the height of the lamellas 337 progresses (in an upwards or downwards direction) in a stepped pattern that alternates between the two opposite sides of the shaft 333. The umbrella cap 335 is dome or mushroom shaped, and has an outer perimeter 339 that flexes and is compressed against the upper surface of the wall panel 65 when the plug 329 is installed, creating a first water barrier. The umbrella cap 335 also includes an outwardly and downwardly extending annular ring 341 that is formed within the perimeter 339 of the cap and extends from an inner/lower surface 345 of the cap. When the plug 329 is installed, the annular ring 341 flexes and is also compressed against the upper surface of the wall panel 65 to provide a second water barrier that further protects against water seeping through the opening 63 and into the interior of the wall panel. An annular flange 347 extends outwardly from the shaft 333 at a position between the umbrella cap 335 and the lamellas 337. When the plug 329 is installed, the annular flange 347 contacts the upper/exterior surface of the wall panel 65 adjacent and around the opening 63, providing a third water barrier.

The plug 329 may be formed by additive manufacturing, injection molding, or other suitable manufacturing process. Hence, the plug 329 may be monolithic in construction. Suitable materials for the plug 329 include resins (e.g. thermoset and/or thermoplastic resins), rubbers/elastomers, and combinations thereof. However, myriad materials may be used to manufacture the plug 329, each typically selected as a function of availability, cost, performance/end use applications, etc. Moreover, rubbers/elastomers and resins are not exhaustive of suitable materials that may be used.

In certain embodiments, the plug 329 comprises a resin, such as a thermoplastic and/or thermoset resin. Examples of suitable resins typically comprise the reaction product of a monomer and a curing agent, although resins formed of self-polymerizing monomers (i.e., those acting as both a monomer and a curing agent) may also be utilized. It is to be appreciated that such resins are conventionally named/identified according to a particular functional group present in the reaction product. For example, the term “polyurethane resin” represents a polymeric compound comprising a reaction product of an isocyanate (i.e., a monomer) and a polyol (i.e., a chain extender/curing agent). The reaction of the isocyanate and the polyol create urethane functional groups, which were not present in either of the unreacted monomer or curing agent. However, it is also to be appreciated that, in certain instances, resins are named according to a particular functional group present in the monomer (i.e., a cure site). For example, the term “epoxy resin” represents a polymeric compound comprising a cross-linked reaction product of a monomer having one or more epoxide groups (i.e., an epoxide) and a curing agent. However, once cured, the epoxy resin is no longer an epoxy, or no longer includes epoxide groups, but for any unreacted or residual epoxide groups (i.e., cure sites), which may remain after curing, as understood in the art. In other instances, however, resins may be named according to a functional group present in both the monomer and the reaction product (i.e., an unreacted functional group).

In some embodiments, the plug 329 may comprise material suitable for use under continuous exposure to temperatures of from −40° C. to 120° C., or from −40° C. to 135° C. and/or pressures of from 0.5 to 2 bar. In certain embodiments, the plug 229 comprises materials that can withstand up to 30 minutes, alternatively more than 30 minutes, of exposure to temperatures of up to 150° C. without irreversible harmful effects (e.g. melting, etc.).

With regard to composition of the plug 329 described above comprising a resin, examples of suitable resins include thermoset resins and thermoplastic resins. Examples of suitable thermoset and/or thermoplastic resins typically include polyamides (PA), such as Nylons; polyesters such as polyethylene terephthalates (PET), polybutylene terephthalates (PET), polytrimethylene terephthalates (PTT), polyethylene naphthalates (PEN), liquid crystalline polyesters, and the like; polyolefins such as polyethylenes (PE), polypropylenes (PP), polybutylenes, and the like; styrenic resins; polyoxymethylenes (POM); polycarbonates (PC); polymethylenemethacrylates (PMMA); polyvinyl chlorides (PVC); polyphenylene sulfides (PPS); polyphenylene ethers (PPE); polyimides (PI); polyamideimides (PAI); polyetherimides (PEI); polysulfones (PSU); polyethersulfones; polyketones (PK); polyetherketones (PEK); polyetheretherketones (PEEK); polyetherketoneketones (PEKK); polyarylates (PAR); polyethernitriles (PEN); resol-type; urea (e.g. melamine-type); phenoxy resins; fluorinated resins, such as polytetrafluoroethylenes; thermoplastic elastomers, such as polystyrene types, polyolefin types, polyurethane types, polyester types, polyamide types, polybutadiene types, polyisoprene types, fluoro types, and the like; and copolymers, modifications, and combinations thereof.

With regard to composition of the plug 329 described above comprising a rubber/elastomer, examples of suitable rubber/elastomers include neoprene rubbers, buna-N rubbers, silicone rubbers, ethylene propylene diene monomer (EPDM) rubbers, natural gum rubbers, viton rubbers, natural latex rubbers, vinyl rubbers, santoprene rubbers, epichlorohydrin (ECH) rubbers, butyl rubbers, latex-free thermoplastic elastomer (TPEs), thermoplastic elastomers, hypalon rubbers, ethylene propylene rubbers, fluoroelastomer rubbers, fluorosilicone rubbers, hydrogenated nitrile rubbers, nitrile rubbers, perfluoroelastomer rubbers, polyacrylic rubbers, polychloroprenes, polyurethanes, aflas rubbers (e.g. TFE/Ps), chlorosulfonated polyethelene rubbers, styrene butadiene rubbers (SBRs), polyacrylates, ethylene acrylic rubbers, polyvinyl chloride (PVC), ethylene-vinyl acetate (EVA), and combinations thereof.

In various embodiments, the plug 329 described above may comprise a material (e.g. a resin, rubber, etc.) including a filler. Examples of suitable fillers include reinforcing fillers added for providing mechanical strength, such as inorganic fillers (e.g. fumed silica fine powder, precipitated silica fine powder, fused silica fined powder, baked silica fine powder, fumed titanium dioxide fine powder, quartz fine powder, calcium carbonate fine powder, diatomaceous earth fine powder, aluminum oxide fine powder, aluminum hydroxide powder, zinc oxide fine powder, zinc carbonate fine powder, glass fibers, etc.), organic fibers (e.g. carbon fibers), natural fibers, and the like, as well as combinations thereof.

It is to be understood that the appended claims are not limited to express and particular compounds, compositions, or methods described in the detailed description, which may vary between particular embodiments which fall within the scope of the appended claims. With respect to any Markush groups relied upon herein for describing particular features or aspects of various embodiments, different, special, and/or unexpected results may be obtained from each member of the respective Markush group independent from all other Markush members. Each member of a Markush group may be relied upon individually and or in combination and provides adequate support for specific embodiments within the scope of the appended claims.

Further, any ranges and subranges relied upon in describing various embodiments of the present invention independently and collectively fall within the scope of the appended claims, and are understood to describe and contemplate all ranges including whole and/or fractional values therein, even if such values are not expressly written herein. One of skill in the art readily recognizes that the enumerated ranges and subranges sufficiently describe and enable various embodiments of the present invention, and such ranges and subranges may be further delineated into relevant halves, thirds, quarters, fifths, and so on. As just one example, a range “of from 0.1 to 0.9” may be further delineated into a lower third, i.e., from 0.1 to 0.3, a middle third, i.e., from 0.4 to 0.6, and an upper third, i.e., from 0.7 to 0.9, which individually and collectively are within the scope of the appended claims, and may be relied upon individually and/or collectively and provide adequate support for specific embodiments within the scope of the appended claims. In addition, with respect to the language which defines or modifies a range, such as “at least,” “greater than,” “less than,” “no more than,” and the like, it is to be understood that such language includes subranges and/or an upper or lower limit. As another example, a range of “at least 10” inherently includes a subrange of from at least 10 to 35, a subrange of from at least 10 to 25, a subrange of from 25 to 35, and so on, and each subrange may be relied upon individually and/or collectively and provides adequate support for specific embodiments within the scope of the appended claims. Finally, an individual number within a disclosed range may be relied upon and provides adequate support for specific embodiments within the scope of the appended claims. For example, a range “of from 1 to 9” includes various individual integers, such as 3, as well as individual numbers including a decimal point (or fraction), such as 4.1, which may be relied upon and provide adequate support for specific embodiments within the scope of the appended claims.

The above description is that of current embodiments of the invention. Various alterations and changes can be made without departing from the spirit and broader aspects of the invention as defined in the appended claims, which are to be interpreted in accordance with the principles of patent law including the doctrine of equivalents. This disclosure is presented for illustrative purposes and should not be interpreted as an exhaustive description of all embodiments of the invention or to limit the scope of the claims to the specific elements illustrated or described in connection with these embodiments. For example, and without limitation, any individual element(s) of the described invention may be replaced by alternative elements that provide substantially similar functionality or otherwise provide adequate operation. This includes, for example, presently known alternative elements, such as those that might be currently known to one skilled in the art, and alternative elements that may be developed in the future, such as those that one skilled in the art might, upon development, recognize as an alternative. Further, the disclosed embodiments include a plurality of features that are described in concert and that might cooperatively provide a collection of benefits. The present invention is not limited to only those embodiments that include all of these features or that provide all of the stated benefits, except to the extent otherwise expressly set forth in the issued claims. Any reference to claim elements in the singular, for example, using the articles “a,” “an,” “the” or “said,” is not to be construed as limiting the element to the singular.

1. A lift nut mounting bracket for hoisting a building wall panel, the lift nut mounting bracket comprising:
a side plate;
a top plate connected to the side plate at a first joint, the top plate including a first opening therein;
a receiving plate adjacent to the top plate;
a receiver formed in the receiving plate, the receiver being aligned with the first opening in the top plate; and
a nut received and retained in the receiver.

2. The lift nut mounting bracket of claim 1, wherein the receiving plate is connected to the top plate at a second joint.

3. The lift nut mounting bracket of claim 1, wherein the receiver is an opening having a shape that corresponds to the cross-sectional shape of the nut.

4. The lift nut mounting bracket of claim 3, wherein the receiver opening has a hexagonal shape.

5. The lift nut mounting bracket of claim 1, wherein the receiving plate is spaced from and overlaps the top plate.

6. The lift nut mounting bracket of claim 1, wherein the side plate is generally perpendicular to the top plate.

7. The lift nut mounting bracket of claim 1, wherein the side plate includes a plurality of apertures for attaching the mounting bracket on a frame member of a wall panel.

8. The lift nut mounting bracket of claim 1, further including at least one tab protrusion extending from the side plate, the at least one tab protrusion contacting the receiving plate and restricting movement of the receiving plate in a direction away from the top plate.

9. The lift nut mounting bracket of claim 1, wherein the side plate, top plate, and receiving plate are monolithic in construction.

10. The lift nut mounting bracket of claim 1, wherein the lift nut mounting bracket is formed of metal, a high-strength low-alloy (HSLA) steel.

11. The lift nut mounting bracket of claim 1, further comprising a retaining tab connected to the side plate at a third joint, the retaining tab including a second opening therein;
wherein the retaining tab secures the nut in the receiver, the first opening is aligned with the second opening, and the first and second openings overlap the receiver.

12. The lift nut mounting bracket of claim 11, wherein the second opening in the retaining tab generally corresponds in size and shape to an internal threaded bore of the nut.

13. The lift nut mounting bracket of claim 11, wherein the retaining tab overlaps the receiving plate and the top plate.

14. The lift nut mounting bracket of claim 11, wherein the retaining tab extends from the side plate.

15. The lift nut mounting bracket of claim 11, wherein the side plate, top plate, receiving plate, and retaining tab are monolithic in construction.

16. The lift nut mounting bracket of claim 1, wherein the nut includes a flange that retains the nut in the receiver.

17. The lift nut mounting bracket of claim 1, wherein the receiving plate is separate from the side plate and the top plate.

18. The lift nut mounting bracket of claim 17, wherein the side plate and the top plate are monolithic in construction, and the receiving plate is formed separate from the side plate and the top plate.

19. The lift nut mounting bracket of claim 1, wherein the receiving plate includes a plurality of raised circular surfaces.

20. The lift nut mounting bracket of claim 1, further comprising a plug inserted into the nut.

21. The lift nut mounting bracket of claim 20, wherein the plug includes a longitudinally extending shaft cooperable with threads of an internal threaded bore of the nut.

22. The lift nut mounting bracket of claim 21, wherein the shaft includes a plurality of lamella that interlock with the threads of the nut.

23. The lift nut mounting bracket of claim 20, wherein the plug includes a flexible umbrella cap on one end of the shaft, the umbrella cap having an outer perimeter.

24. The lift nut mounting bracket of claim 23, wherein the umbrella cap includes an outwardly and downwardly extending annular ring within the outer perimeter.

25. The lift nut mounting bracket of claim 21, wherein the shaft includes an outwardly extending annular flange.

26. A lift nut mounting bracket comprising:
a single metal piece forming:
a side section for connection to a frame of a wall panel;
a top section that merges into the side section via a first bending section that is bent around a first bending axis, wherein the top section, the first bending section, and the side section form an angle of approximately 90 degrees;
the top section including a first opening;
a folded receiving section that merges into the top section via a second bending section that is bent around a second bending axis, wherein the receiving section, the second bending section, and the top section form an angle of approximately 180 degrees; and
a receiver formed in the receiving section, the receiver overlapping the first opening in the top section; and
a nut received and retained in the receiver.

27. The lift nut mounting bracket of claim 26, wherein the receiving section overlaps the top section and is spaced from the top section.

28. The lift nut mounting bracket of claim 26, wherein the side section is generally perpendicular to the top section.

29. The lift nut mounting bracket of claim 26, wherein the first and second bending axes are generally parallel to each other, and the first and second bending axes are generally perpendicular to a longitudinal axis of the metal piece.

30. The lift nut mounting bracket of claim 26, further including at least one tab protrusion extending from the side plate, the at least one tab protrusion contacting the receiving plate and restricting movement of the receiving plate in a direction away from the top plate.

31. The lift nut mounting bracket of claim 26, further comprising a retaining tab section that merges into the side section via a third bending section that is bent around a third bending axis;
wherein the retaining tab section, the third bending section, and the side section form an angle of approximately 90 degrees, wherein the third bending section is formed in the side section, wherein the retaining tab section extends from the side section, and wherein the retaining tab section includes a second opening that is aligned with the first opening in the top section.

32. The lift nut mounting bracket of claim 31, wherein the first, second, and third bending axes are generally parallel to each other, and the first, second, and third bending axes are generally perpendicular to a longitudinal axis of the metal piece.

33. The lift nut mounting bracket of claim 31, wherein the retaining tab section secures the nut in the receiver, and the retaining tab section overlaps the receiving section and the top section.

34. A method of manufacturing a lift nut mounting bracket, the method comprising the steps of:
providing a single metal piece;
forming a receiver and a first circular opening in the single metal piece, wherein the receiver and the first circular opening are generally aligned along a longitudinal axis of the single metal piece;
bending the single metal piece along a first bending axis positioned opposite the receiver relative to the first circular opening to form a side section that is continuous with and merges with a top section; and
bending the single metal piece along a second bending axis positioned between the first circular opening and the receiver to form a receiving section that is continuous with and merges with the top section, the receiving section being folded over the top section, wherein the receiving section overlaps and is spaced from the top section.

35. The method of claim 34, wherein the single metal piece has an inner face, an opposite outer face, and a peripheral edge at an end thereof; and
the peripheral edge contacts the inner face after bending the single metal piece along the second bending axis to form the receiving section.

36. The method of claim 34, further including the step of disposing a nut in the receiver.

37. The method of claim 34, wherein the first bending axis and the second bending axis are generally perpendicular to the longitudinal axis; and
the first and second bending axes are generally parallel to each other.

38. The method of claim 34, further including the steps of:
forming a second circular opening in the single metal piece, wherein the receiver, the first circular opening, and the second circular opening are generally aligned along the longitudinal axis of the single metal piece; and
forming a retaining tab section that surrounds the second circular opening, wherein the retaining tab section is formed as a cutout in the single metal piece, and only one edge of the retaining tab section is continuous with the single metal piece.

39. The method of claim 38, further including the steps of:
disposing a nut in the receiver; and
bending the retaining tab section along a third bending axis to secure the nut in the receiver, wherein the third bending axis is formed along the said only one edge of the retaining tab section.

40. The method of claim 38, wherein the first bending axis, the second bending axis, and the third bending axis are generally perpendicular to the longitudinal axis; and
the first, second, and third bending axes are generally parallel to each other.

41. The method of claim 38, wherein the single metal piece has an inner face, an opposite outer face, and a peripheral edge at an end thereof, the method further including the step of bending the retaining tab section along a third bending axis, wherein the third bending axis is formed along the said only one edge of the retaining tab section, and wherein the retaining tab section is bent in a direction faced by the inner face of the single metal piece and away from a direction faced by the outer face of the single metal piece.
